(19) United States
(12) Patent Application Publication
(10) Pub. No.: US 2022/0009409 A1
(43) Pub. Date: Jan. 13, 2022

(54) Vehicle Light and Vehicle Including a Vehicle Light

(71) Applicant: Bayerische Motoren Werke Aktiengesellschaft, Muenchen (DE)

(72) Inventors: Simon PAUL, Biberach an der Riss (DE); Volker SCHUMACHER, Bad Waldsee (DE); Reinhard SEIFRIED, Unterhaching (DE); Marc DE WILLE, Muenchen (DE)

(21) Appl. No.: 17/292,938

(22) PCT Filed: Nov. 13, 2019
(86) PCT No.: PCT/EP2019/081091

§ 371 Date: May 11, 2021

(30) Foreign Application Priority Data
Nov. 27, 2018 (DE) 10 2018 129 989.3

(51) Int. Cl. B60Q 1/32; B60Q 1/26; B60Q 1/00; F21S 41/143; F21S 41/255; F21S 41/47

(52) U.S. Cl. CPC B60Q 1/323; B60Q 1/2696; B60Q 1/0029; F21W 2102/40; F21S 41/255; F21S 41/47; B60Q 2400/40; F21S 41/143

(57) ABSTRACT

A vehicle light includes at least one light-emitting diode and a free-form optical element optically downstream of the at least one light-emitting diode. A diaphragm is mounted on a side of the free-form optical element that faces the at least one light-emitting diode. A vehicle includes at least one such vehicle light.

### BACKGROUND AND SUMMARY OF THE INVENTION

The invention relates to a vehicle light including at least one light-emitting diode (LED) and an optical unit disposed optically downstream thereof. The invention also relates to a vehicle including at least one such vehicle light. The invention is advantageously applicable in particular to environment projectors for illuminating an access region of motor vehicles, in particular automobiles.

In the case of vehicle lights, freeform optical units can be used to shape the luminous flux of an LED such that a light emission pattern with a predefined illuminance distribution is generated on a surface next to the vehicle. In particular, there may be a desire to illuminate a delimited area in an access region with a homogeneous illuminance.

If offset tolerances between an LED and an optical unit become excessively large during the production of such a vehicle light in a series manufacturing process, it can no longer be ensured that the desired illuminance distribution, in particular homogeneous illumination, is brought about at the area of the ground. Since a freeform optical unit is typically particularly susceptible to an offset, hitherto it has been necessary, disadvantageously, for a particularly high manufacturing and/or assembly outlay to be expended in order to provide correctly set vehicle lights. In this case, particularly in the case of light projectors for illuminating an access region of motor vehicles, it is disadvantageous that they generally have to be particularly compact and an offset during their manufacture is therefore particularly disadvantageous, especially since an adjustment then—if at all possible or practical in terms of costs—is feasible only with a very high outlay and complexity.

The object of the present invention is to at least partly overcome these disadvantages and, in particular using structurally simple and inexpensive means, to provide a vehicle light whose target light emission pattern is better able to be complied with, in particular an environment projector for illuminating an access region of a motor vehicle.

This object is achieved according to the features of the claimed invention.

The object is achieved by a vehicle light comprising at least one light-emitting diode and a freeform optical unit disposed optically downstream thereof, wherein a diaphragm is applied to a side of the freeform optical unit facing the at least one light-emitting diode.

This achieves the advantage that the dependence of the generated light emission pattern on the positional relationship between the optical unit and the LED(s) is reduced and the optical system is able to be produced more simply in a series process. This is achieved by virtue of the fact that the edge or the contour of the light beam incident on the freeform optical unit is now offset-independent and, therefore, that part of the light beam which reaches the freeform optical unit is extremely offset-independent. These advantages are achievable particularly effectively for compact lights which are intended to generate a homogeneous light emission at a comparatively short distance but with a wide illumination range in front of the light, e.g. in the case of environment projectors for illuminating an access region. These advantages are furthermore achievable particularly effectively if a distance between the at least one LED and the freeform optical unit is small in comparison with a diameter or a lateral dimension of the freeform optical unit. Moreover, the diaphragm is advantageously attachable to the freeform optical unit with high accuracy.

In one development, the vehicle light is an environment projector or environment spotlight, in particular for illuminating an access region. However, the vehicle light is not restricted thereto and can e.g. also be a vehicle headlight, e.g. a front headlight. In one development, the vehicle headlight can be a headlight for generating a low beam, a high beam, a fog light, a cornering light, etc. or any desired combination thereof

The vehicle can be a land vehicle such as an automobile, truck, bus, train, motorcycle, etc., an aircraft such as an airplane or a helicopter, or a waterborne vehicle such as a ship, etc. The land vehicle can be, in particular, an at least partly electrically driven vehicle.

The at least one light-emitting diode can comprise exactly one light-emitting diode or a plurality of light-emitting diodes. If a plurality of light-emitting diodes are present, they can be arranged on a common substrate. The at least one light-emitting diode can be a packaged light-emitting diode or an LED chip. The at least one light-emitting diode can emit Economic Commission for Europe (ECE)-conforming white light.

The fact that the freeform optical unit is disposed optically downstream of the at least one light-emitting diode means, in particular, that the freeform optical unit is situated in the light path of the light emitted by the at least one light-emitting diode.

A freeform optical unit can be understood to mean, in particular, an optical unit or an optical system having refractive and/or reflective surfaces that differ from conventional spherical and aspherical geometries. The design thereof no longer necessarily follows the concepts of imaging optics, but rather is aimed at redistributing energy by light refraction and/or light reflection.

The freeform optical unit can generally comprise at least one freeform or freely shaped optical element. It can additionally comprise one or more conventional (not freely shaped) optical elements. At least one freely shaped optical element can be a transmitted-light element (“freeform lens”). In one development, the freeform optical unit can comprise exactly one freely shaped optical element. In one configuration, the freeform optical unit can consist of exactly one freeform lens (and no other optical element arranged separately therefrom) or correspond to a single freeform lens.

In one configuration, the freeform optical unit consists of a plurality of optical elements, at least one optical element of which is a freeform lens.

In one development, the diaphragm is arranged at that optical element on which the light emitted by the at least one light-emitting diode impinges first. In one development, the diaphragm is arranged at an optical element embodied as a freeform lens. This freeform lens can be, but need not be, the first optical element in the beam path. Generally, a plurality of diaphragms can also be attached to a plurality of freeform lenses and/or other optical elements of a freeform optical unit.

The fact that the diaphragm is arranged at a side of the freeform optical unit facing the at least one light-emitting diode can encompass the fact that the diaphragm is arranged on a light incidence surface of the optical unit.

The diaphragm can comprise one or more openings provided for the transmission of light. The contour of the at least one opening can be of any desired shape and/or size in principle.

In one configuration, the diaphragm is a film applied to an optical element of the freeform optical unit. If the freeform optical unit consists only of a freeform lens, the film is applied on this lens.

In one configuration, the diaphragm is embodied as a layer applied by vapor deposition, spraying or printing.

In one configuration, the diaphragm has been produced in a manner integrated with the optical element of the freeform optical unit. In one development, the optical element is a multi-component injection-molded part, e.g. composed of plastic, wherein the diaphragm then constitutes an, in particular optically nontransmissive, partial region of the optical element. Such an optical element (which can be regarded e.g. as a freeform lens with an integrated diaphragm or as a freeform lens-diaphragm combination) can be a two-component injection-molded part, in particular.

In one configuration, the diaphragm is embodied as light-absorbing, at least at its side facing the at least one light-emitting diode.

The object is also achieved by a vehicle comprising at least one vehicle light as described above. The vehicle can be embodied analogously to the vehicle light and has the same advantages.

In this regard, in one configuration, the vehicle can comprise a plurality of environment projectors, e.g. in each case one environment projector for illuminating an area of the ground in front of each of the two sides of a vehicle, in each case one environment projector for illuminating an area of the ground in front of each of the doors of a vehicle, etc.

If the vehicle comprises a plurality of vehicle lights in the form of vehicle headlights, the diaphragms can be fashioned identically or differently, e.g. differently for left- and right-hand front headlights. Different diaphragms can comprise different shaped, different sized and/or differently arranged openings.

The above-described properties, features and advantages of this invention and the way in which they are achieved will become clearer and more clearly understood in association with the following schematic description of an exemplary embodiment which is explained in greater detail in association with the drawings.

### BRIEF DESCRIPTION OF THE DRAWINGS

FIG. 1 shows as a sectional illustration, in a side view, selected components of a vehicle headlight according to the invention.

FIG. 2 shows a diaphragm of the vehicle headlight from FIG. 1 in a front view.

### DETAILED DESCRIPTION OF THE DRAWINGS

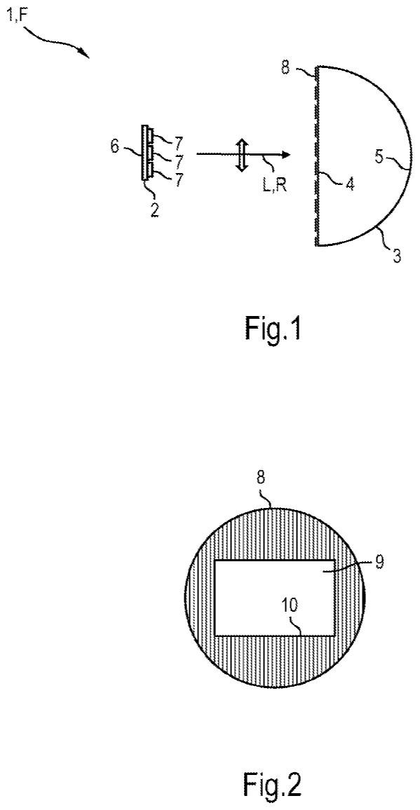

FIG. 1 shows as a sectional illustration, in a side view, components of a vehicle light according to the invention in the form of an environment projector 1, specifically a light generating module 2 and a freeform optical unit in the form of a single freeform lens 3 shown by way of example here. The freeform lens 3 depicted is illustrated, without being faithfully realistic, as a conventional planoconvex lens having a light incidence surface 4 facing the light generating module 2 and a light emission surface 5 facing away from the light generating module 2. In reality, however, the light incidence surface 4 and/or the light emission surface 5 are/is freely shaped in a complex manner.

The light generating module 2 here comprises a plurality of LED chips 7 applied on a common substrate 6, the light L from said chips being directed along a main emission direction R onto the light incidence surface 4. The light L can be white, ECE-conforming light. The LED chips 7 can be arranged in a matrix-like fashion with respect to one another. The light generating module 2 can comprise one or more primary and/or secondary optical units (not illustrated) for beam shaping of the light L emitted by the light generating module 2, e.g. for beam focusing, collimation, etc.

A light coupling-out optical unit (not illustrated) for coupling out the light L emitted by the freeform lens 3 can be disposed optically downstream of the freeform lens 3.

Between the light generating module 2 and the freeform lens 3, an offset with respect to a target position can occur, e.g. in the context of an assembly of the environment projector 1. A relative offset that is lateral or perpendicular with respect to the main emission direction R is indicated here purely by way of example by the double-headed arrow; however, a longitudinal offset can also occur, in the case of which the distance between light generating module 2 and freeform lens 3 changes or is established incorrectly.

In order to reduce an effect of the offset, here a ply- or layer-like diaphragm 8 is applied to the light incidence surface 4 of the freeform lens 3, e.g. in the form of a film adhering thereon, or a layer applied thereto by vapor deposition, spraying or printing, etc. Alternatively, the diaphragm 8 can be embodied as an optically nontransmissive partial region of the freeform lens 3 produced as a multi-component injection-molded part.

In order to avoid unwanted reflection effects in the light L emitted by the freeform lens 3, the diaphragm 8 can be embodied as light-absorbing at least at its side facing the light generating module 2, for example in matte black.

The environment projector 1 can constitute one, in particular one of a plurality of, environment projectors 1 of a vehicle F.

FIG. 2 shows the diaphragm 8 of the environment projector 1 in a front view, in particular in the direction of the main emission direction R or counter to the main emission direction R (the view then being directed toward the light generating module 2). The diaphragm 8 here comprises an opening 9 having for example a rectangular contour 10.

It goes without saying that the present invention is not restricted to the exemplary embodiment shown.

Generally, “a(n)”, “one” etc. can be understood as a singular or a plural, particularly in the sense of “at least one” or “one or more” etc., as long as this is not explicitly excluded, e.g. by the expression “exactly one” etc.

### LIST OF REFERENCE SIGNS

1 Environment projector
2 Light generating module
3 Freeform lens
4 Light incidence surface
5 Light emission surface
6 Substrate
7 LED chip
8 Diaphragm
9 Opening
10 Contour
F Vehicle
L Light
R Main emission direction

1.-9. (canceled)

10. A vehicle light comprising:
at least one light-emitting diode;
a freeform optical unit disposed optically downstream of the at least one light-emitting diode; and
a diaphragm that is applied to a side of the freeform optical unit facing the at least one light-emitting diode.

11. The vehicle light according to claim 10, wherein the diaphragm is a film that is applied to an optical element of the freeform optical unit.

12. The vehicle light according to claim 10, wherein the diaphragm is a layer that is applied to an optical element of the freeform optical unit by vapor deposition, spraying or printing.

13. The vehicle light according to claim 10, wherein the diaphragm is an optically nontransmissive partial region of an optical element of the freeform optical unit, wherein the optical element is produced as a multi-component injection-molded part.

14. The vehicle light according to claim 10, wherein the diaphragm is light-absorbing at least at a side facing the at least one light-emitting diode.

15. The vehicle light according to claim 10, wherein the freeform optical unit consists of a freeform lens.

16. The vehicle light according to claim 10, wherein the freeform optical unit comprises a plurality of optical elements, and at least one optical element of the plurality of optical elements is a freeform lens.

17. A vehicle comprising at least one vehicle light according to claim 10.

18. The vehicle according to claim 17, wherein the vehicle light is an environment projector for illuminating an area of ground at an access region.
